(19) United States
(12) Patent Application Publication
(10) Pub. No.: US 2025/0023050 A1
(43) Pub. Date: Jan. 16, 2025

(54) ANODE FOR LITHIUM SECONDARY BATTERY AND LITHIUM SECONDARY BATTERY COMPRISING THE SAME

(71) Applicant: SK On Co., Ltd., Seoul (KR)

(72) Inventor: Kwang Ho JEONG, Daejeon (KR)

(21) Appl. No.: 18/766,653

(22) Filed: Jul. 9, 2024

(30) Foreign Application Priority Data
Jul. 14, 2023 (KR) 10-2023-0091978

(51) Int. Cl. H01M 4/62; H01M 4/02; H01M 4/133; H01M 4/36; H01M 4/48; H01M 4/583

(52) U.S. Cl. CPC H01M 4/622; H01M 4/133; H01M 4/364; H01M 4/483; H01M 4/583; H01M 2004/027

(57) ABSTRACT

An anode for a lithium secondary battery includes an anode mixture layer including a silicon-based anode active material and a binder, wherein the binder includes styrene butadiene rubber (SBR) and a polyacrylic acid (PAA)-based binder, and the SBR has a Young's modulus of 10.1 kPa to 29.0 kPa. According to the present disclosure, an anode for a secondary battery and a lithium secondary battery including a silicon-based anode active material to have excellent capacity characteristics and including a polyacrylic acid-based binder to improved have battery resistance characteristics, while suppressing volume expansion of the silicon-based anode active material during charging and discharging.

### CROSS-REFERENCE TO RELATED APPLICATION(S)

This patent document claims the priority and benefits of Korean Patent Application No. 10-2023-0091978 filed on Jul. 14, 2023, the disclosure of which is incorporated herein by reference in its entirety.

### TECHNICAL FIELD

The disclosure and implementations disclosed in this patent document generally relate to an anode for a lithium secondary battery and a lithium secondary battery including the anode.

### BACKGROUND

Since secondary batteries are easy to apply depending on the product group and have desirable electrical characteristics, such as high energy density, secondary batteries have been widely applied not only to portable devices but also to electric vehicles or hybrid vehicles driven by an electrical driving source and power storage devices. Secondary batteries have emerged as a new energy source for improving eco-friendliness and energy efficiency in that by-products due to energy use do not occur, as well as primary advantages of significantly reducing the use of fossil fuels.

Accordingly, technological development of secondary batteries has continuously expanded, and as the need for high-energy secondary batteries having high energy density has increased, development and research on high-capacity anodes therefor has also been actively underway.

Recently, in order to implement secondary batteries with high capacity and high energy density, silicon-based anode active materials with a higher discharge capacity than graphite have been applied to anodes for secondary batteries. Anodes using a silicon-based anode active material are known to have a theoretical capacity of 3580 mAh/g, several times greater than the theoretical capacity of 372 mAh/g for anodes using a graphite-based active material. For this reason, silicon-based anode active materials have come to prominence as anodes for lithium secondary batteries to be used in next-generation mobile devices, electric vehicles (EVs), energy storage systems (ESS), etc.

However, silicon-based anode active materials have a volume expansion rate twice or more that of graphite, and this high volume causes expansion relatively large contraction/expansion of the anode during a repetitive charging/discharging process of batteries, resulting in delamination of the active material layer, an increase in internal resistance of electrodes, side reactions with the electrolyte, and a decrease in the lifespan characteristics of the electrodes. Therefore, there is a need for a technology to increase battery capacity and suppress the volume expansion rate by using a silicon-based anode active material.

### SUMMARY

The present disclosure may be implemented in some embodiments to provide an anode for a lithium secondary battery capable of suppressing volume expansion of a silicon-based anode active material.

The present disclosure may be implemented in some embodiments to provide an anode for a lithium secondary battery capable of improving adhesion between an anode mixture layer and an anode current collector.

The present disclosure may be implemented in some embodiments to provide a lithium secondary battery having excellent capacity characteristics, resistance characteristics, lifespan characteristics, and the like by including an anode for a secondary battery having excellent lifespan characteristics by suppressing volume expansion of a silicon-based anode active material during charging/discharging.

In some embodiments of the present disclosure, an anode for a lithium secondary battery includes: an anode mixture layer including a silicon-based anode active material and a binder, wherein the binder includes styrene butadiene rubber (SBR) and a polyacrylic acid (PAA)-based binder, and the SBR has a Young's modulus of 10.1 kPa to 29.0 kPa.

The SBR may have a Young's modulus of 15.8 kPa to 24.2 kPa.

The polyacrylic acid-based binder may include polyacrylic acid, polyacrylic acid-based copolymer, or combinations thereof.

The polyacrylic acid-based copolymer may be a copolymer of polyacrylic acid and any one selected from polyacrylic amide, polyimide, polyvinyl alcohol, and combinations thereof.

The polyacrylic acid-based binder may include a polyacrylic acid-based copolymer including 43.3 to 55.0 mol % of polyacrylic acid.

The binder may include a polyacrylic acid-based binder and SBR in a weight ratio of 1:0.1 to 1:1.

The anode mixture layer may include 2.4 to 5 wt % of a binder.

The silicon-based negative active material may be at least one selected from the group consisting of SiOx (0≤x<2), SiOx doped with a metal element, and SiC.

The anode mixture layer may further include a carbon-based anode active material.

The anode mixture layer may include 5 to 80 wt % of a silicon-based anode active material.

In some embodiments of the present disclosure, a lithium secondary battery is provided, and the lithium secondary battery includes an anode for a secondary battery according to one of the implementation examples described above.

### DETAILED DESCRIPTION

Hereinafter, the present disclosure is described in detail. However, this is merely illustrative and the present disclosure is not limited to the specific embodiments described by way of example.

The present disclosure relates to an anode including a silicon-based anode active material and provides an anode improved in problems, such as electrode peeling, increased resistance, and lifespan shortening due to volume expansion even when silicon-based particles having significant contraction and expansion characteristics are used as an anode active material during a charging/discharging process.

The anode according to the present disclosure includes a silicon-based anode active material and a binder, and the binder includes styrene-butadiene rubber (SBR) and polyacrylic acid (PAA)-based binder.

The SBR includes a repeating unit of a styrene-derived structure and a repeating unit of a butadiene-derived structure, and SBR commonly used in the manufacturing of anodes for secondary batteries may be suitably used in the present disclosure without a particular limitation.

The repeating unit of the butadiene-derived structure constituting the SBR may be a repeating unit of a structure derived from 1,3-butadiene, such as 1,3-butadiene, isoprene, 2,3-dimethyl-1,3-butadiene, or 2-ethyl-1,3-butadiene, or derivatives thereof, but is not limited thereto.

In addition, the repeating unit of the styrene-derived structure may be a repeating unit of a structure derived from styrene, an aromatic vinyl compound, such as styrene, α-methylstyrene, p-methylstyrene, 3-methylstyrene, 4-methylstyrene, 4-propylstyrene, 1-vinylnaphthalene, 4-cyclohexylstyrene, 4-(p-methylphenyl) styrene, and 1-vinyl-5-hexylnaphthalene, or derivatives thereof, but is not limited thereto.

In the present disclosure, as the above SBR, SBR having a Young's modulus of 10.1 kPa to 29.0 kPa may be used.

Young's modulus is a measure of resistance of a material to pulling or compression and may also be referred to as a length elastic modulus as an elastic modulus indicating the degree to which an object is stretched and deformed when stretched from both sides.

In the SBR, Young's modulus is affected by the glass transition temperature (Tg). Specifically, the Young's modulus tends to increase as the glass transition temperature of SBR increases. Meanwhile, the glass transition temperature tends to be proportional to the styrene content included in SBR. Therefore, by lowering the butadiene content or increasing the styrene content included in SBR, the glass transition temperature of SBR may be increased, and further, the Young's modulus of SBR may be increased.

The Young's modulus of SBR may be measured using universal testing machine (UTM) (INSTRON, 34TM-10). Specifically, SBR may be dried at 40° C. for 48 hours and further dried in a 60° C. vacuum oven for 6 hours to prepare a film having a thickness of 200 to 500 μm, for example, 300 μm, the dried film may be punched to have a width of 9.5 mm to manufacture a specimen, the specimen is pulled at a speed of 20 mm/min using UTM to measure tensile strength when the specimen is deformed or broken, and the Young's modulus may be calculated from a slope of the tensile strength-strain.

In the present disclosure, when the Young's modulus of the SBR has a value within the above range, the SBR does not lose elasticity and maintains the characteristics of the original material even if the volume of the anode expands during the charging and discharging process of the battery, and the SBR may be recovered to its original state even after shrinkage/expansion, thereby continuously providing binding force as a binder. Therefore, even if the anode contracts/expands during the charging and discharging process of the battery, peeling of the anode mixture layer from the anode current collector may be prevented, the anode active material may be prevented from being detached from the anode mixture layer, or an increase in resistance of the electrode and a reduction in lifespan of the battery may be prevented or suppressed.

Specifically, when the Young's modulus of the SBR is 10.1 kPa or more, the volume expansion characteristics of the anode during the charging/discharging process may be controlled, and when the Young's modulus of the SBR is 29.0 kPa or less, stability of the SBR itself may be promoted to prevent the occurrence of particle agglomeration during the anode manufacturing process, and the distribution of SBR within the electrode is uniform, thereby preventing an increase in resistance within the anode and further improving lifespan characteristics.

More specifically, when the Young's modulus of the SBR is 15.8 kPa to 24.2 kPa, the capacity retention rate may be improved by increasing battery capacity and more effectively suppressing volume expansion of the anode. In addition, an increase in resistance within the anode and a decrease in battery lifespan may be further suppressed.

The anode according to the present disclosure may include a polyacrylic acid-based binder. Polyacrylic acid is a polymer having repeating units of acrylic acid monomer. The polyacrylic acid-based binder in the present disclosure may be a homopolymer or a copolymer as long as it is a polymer having repeating units of acrylic acid monomer.

Polyacrylic acid polymerized from the acrylic acid monomer includes an acrylate group, and the acrylate group has excellent affinity with an electrolyte. Therefore, when polyacrylic acid having such an acrylate group is included as a binder, resistance characteristics of the battery may be further improved due to excellent affinity with the electrolyte and electrolyte uptake.

The polyacrylic acid-based binder may include polyacrylic acid, polyacrylic acid-based copolymer, or combinations thereof. The polyacrylic acid copolymer is not particularly limited, and any polyacrylic acid-based binder including the acrylate-based monomer and used as a binder in the production of an anode may be suitably used in the present disclosure. For example, the polyacrylic acid-based copolymer may be a copolymer of any one selected from polyacrylic amide, polyimide, polyvinyl alcohol, and combinations thereof, and polyacrylic acid as described above.

The polyacrylic acid-based copolymer may be a copolymer including 43.3 to 55.0 mol % of polyacrylic acid. When a polyacrylic acid-based copolymer including polyacrylic acid at a molar ratio within the above range is included as a binder, the volume expansion of the silicon anode material may be further suppressed and the brittleness of polyacrylic acid may be further reduced. As a result, it is possible to more effectively prevent or improve problems, such as peeling of the anode due to expansion and contraction of the anode that occurs during charging and discharging of the battery, a resultant increase in internal resistance of the anode, and a reduced battery lifespan.

In the present disclosure, there is no particular limitation, but the polyacrylic acid-based binder may be included in an amount greater than or equal to that of the SBR. More specifically, the polyacrylic acid-based binder and SBR may be included in a weight ratio of 1:0.1 to 1:1, or 1:0.2 to 1:0.5.

When the weight ratio of the SBR to the polyacrylic acid binder is 0.1 or more, adhesion by the SBR may be secured and the internal resistance characteristics of the battery may be improved. More specifically, when the weight ratio of SBR to the polyacrylic acid binder is 0.2 or more, the internal resistance characteristics of the battery may be further improved.

When the polyacrylic acid-based binder is included in an amount greater than the content of the SBR, that is, when the weight ratio of the SBR to the polyacrylic acid-based binder is 1 or less, the effect of suppressing the volume expansion of the anode may be exerted. More specifically, when the weight ratio of the SBR to the polyacrylic acid binder is 0.5 or less, the effect of suppressing the volume expansion of the anode may be maximized.

In the present disclosure, the binder, that is, the binder including SBR and a polyacrylic binder, may be included in an amount of 2.4 to 5 wt % based on the total weight of the anode mixture layer. When the anode mixture layer includes 2.4 wt % or more of the binder, the effect of suppressing expansion of a silicon anode material may be sufficiently exerted, and when the anode mixture layer includes 5 wt % or less, the binder content may be prevented from becoming excessive, thereby improving resistance characteristics of the electrode, and as a result, battery performance may be improved.

In the present disclosure, the anode mixture layer includes a silicon-based anode active material as an anode active material, and a silicon-based anode active material generally used as an anode active material in lithium secondary batteries may be suitably used as the silicon-based anode active material. For example, at least one selected from the group consisting of SiOₓ (0≤x<2), SiOₓ doped with a metal element, and SiC may be used.

The silicon-based anode active material may be included in an amount of 5 to 80 wt % based on the total weight of the anode mixture layer, but is not limited thereto. If the silicon-based anode active material is less than 5 wt % based on the total weight of the anode mixture layer, there is a problem in that the capacity of the battery may be small. If the silicon-based anode active material exceeds 80 wt % based on the total weight of the anode mixture layer, the volume expansion of the anode may be excessive, making it difficult to improve the volume expansion rate even if the binder of the present disclosure is applied.

The anode mixture layer may adsorb and desorb lithium ions along with the silicon-based anode active material and may also include an anode active material (a second anode active material) known in the art. As the second anode active material, for example, a carbon-based material, such as crystalline carbon, amorphous carbon, a carbon composite, and carbon fiber; a lithium metal; a lithium alloy; a tin (Sn)-containing material, etc. may be used.

Examples of the amorphous carbon may include hard carbon, soft carbon, coke, mesocarbon microbeads (MCMB), and mesophase pitch-based carbon fiber (MPCF).

Examples of the crystalline carbon may include graphite-based carbon, such as natural graphite, artificial graphite, graphitized coke, graphitized MCMB, and graphitized MPCF.

The lithium metal may include pure lithium metal or lithium metal with a protective layer formed thereon to inhibit dendrite growth.

Elements included in the lithium alloy may include aluminum, zinc, bismuth, cadmium, antimony, silicon, lead, tin, gallium, and indium.

When the anode mixture layer includes the second anode active material, the second anode active material may be included in an amount of 50 to 90 wt % based on the total weight of the anode mixture layer, but is not limited thereto.

The anode mixture layer may further include a conductive material. The conductive material is used to provide conductivity to the electrode and maintain the structure of the electrode, and any material having conductivity without causing side reactions with other elements of the secondary battery may be used. For example, the conductive material may include one or two or more types of graphite, such as natural graphite or artificial graphite; carbon-based materials, such as carbon black, acetylene black, Ketjen black, channel black, furnace black, lamp black, summer black, carbon fiber, and carbon nanotubes (CNT); metal powder particles or metal fibers, such as copper, nickel, aluminum, and silver; conductive whiskers, such as zinc oxide and potassium titanate; conductive metal oxides, such as titanium oxide; or conductive polymers, such as polyphenylene derivatives.

Specifically, the conductive material may include one or two or more types of single-walled carbon nanotubes (SWCNTs) or multi-walled carbon nanotubes (MWCNTs). Carbon nanotubes (CNTs) may have higher electron mobility than existing conductive materials, such as carbon black, may be able to realize high energy density even by a small amount, may have high strength due to a stable structure thereof, and substantially alleviate the volume expansion of silicon-based active materials. Therefore, when the conductive material includes carbon nanotubes (CNTs), such as single-walled carbon nanotubes (SWCNTs), the energy density, lifespan characteristics, and resistance characteristics of the electrode may be superior.

The conductive material may be included in an amount of 0.01 to 10 wt %, 0.1 to 5 wt %, or 0.3 to 1 wt % based on the total weight of the anode mixture layer but is not limited thereto.

An anode mixture layer may be prepared by mixing the anode active material, the binder, and the optional conductive material, as described above, in a solvent.

An anode solvent may be at least one selected from the group consisting of water, pure water, deionized water, distilled water, ethanol, isopropanol, methanol, acetone, n-propanol, and t-butanol, but is not limited thereto.

The anode mixture layer may be coated on an anode current collector and then dried and rolled to manufacture an anode. The coating process may be performed using methods, such as doctor blade coating, dip coating, bar coating, and casting, but is not limited thereto.

The anode current collector may be formed of one selected from the group consisting of copper foil, nickel foil, stainless steel foil, titanium foil, nickel foam, copper foam, a polymer substrate coated with a conductive metal, and combinations thereof, but is not limited thereto. At this time, the anode current collector may be, for example, 10 to 50 μm.

In the anode according to the present disclosure, a loading weight (LW) of the anode mixture layer may be 0.1 to 15.0 mg/cm². The loading weight (LW) refers to the amount of the anode mixture layer formed on the current collector, that is, the layer including the active material, the binder, the conductive material, etc., formed on a cross-section of the current collector expressed in units of weight per area. At this time, the area is based on the area of the current collector, and the weight is based on the weight of the entire anode mixture layer being formed.

As the anode current collector, one selected from the group consisting of copper foil, nickel foil, stainless steel foil, titanium foil, nickel foam, copper foam, a polymer substrate coated with a conductive metal, and combinations thereof may be used appropriately.

The method of manufacturing an anode for a secondary battery of the present disclosure is not particularly limited, and the anode may be manufactured by preparing a slurry by adding a solvent to a mixture of an anode active material, a conductive material, and a binder, applying the prepared slurry to the anode current collector, and drying the same to form an anode mixture layer.

The solvent may be dimethyl sulfoxide (DMSO), isopropyl alcohol, N-Methyl pyrrolidone (NMP), acetone, or water. Not only may any one of these be used alone, but two or more thereof may be used in combination.

An electrode assembly may be manufactured using the anode described above, a cathode, and a separator and accommodating the electrode assembly in a battery case to manufacture a secondary battery.

### EXAMPLE

Hereinafter, implementation examples are described in more detail through examples. However, the following examples show specific examples of implementing the present embodiment and are not intended to limit the present embodiment.

### Example 1

### 1) Manufacturing of Anode

Based on a solids content, 20 wt % of silicon-based anode active material (SiOₓ), 76.9 wt % of carbon-based anode active material (graphite), 0.1 wt % of conductive material (single-walled carbon nanotube (SWCNT)), 2 wt % of polyacrylic acid (PAA)-based binder (PAA 49.3 mol %), a copolymer of polyacrylic acid (PAA) and polyvinyl alcohol (PVA), and 1 wt % of SBR (Young's modulus of 10.1 kPa) were mixed to prepare an anode slurry. The properties of the binder in the anode slurry are summarized in Table 1.

The prepared anode slurry was applied to both sides of the anode current collector (Cu-Foil, thickness 8 μm) at a loading weight (LW) of 9 mg/cm² per each side, then dried with hot air at 110° C. and rolled to form an anode mixture layer to manufacture an anode.

### 2) Manufacturing of Secondary Battery

A cathode was manufactured by applying a slurry including an NCM-based active material, a lithium-transition metal complex oxide, on aluminum foil and drying the same.

A polyolefin separator was interposed between the anode and the cathode prepared above, which was introduced into a pouch case, and then an electrolyte including 1M of LiPF₆ dissolved therein was injected into a mixture solvent of ethylene carbonate (EC) and diethyl carbonate (DEC), and then sealed to manufacture a pouch-type lithium secondary battery.

### Example 2

An anode was manufactured in the same manner as in Example 1, except that SBR (Young's modulus 15.8 kPa) as shown in Table 1 was used instead of the SBR used in Example 1.

A pouch-type lithium secondary battery was manufactured in the same manner as Example 1 using the prepared anode.

### Example 3

An anode was manufactured in the same manner as in Example 1, except that SBR (Young's modulus 24.2 kPa) as shown in Table 1 was used instead of the SBR used in Example 1.

A pouch-type lithium secondary battery was manufactured in the same manner as Example 1 using the prepared anode.

### Example 4

An anode was manufactured in the same manner as in Example 1, except that a polyacrylic acid binder (43.2 mol % of PAA), a copolymer of polyacrylic acid (PAA) and polyvinyl alcohol (PVA), as shown in Table 1 was used instead of the polyacrylic acid binder used in Example 1.

A pouch-type lithium secondary battery was manufactured in the same manner as Example 1 using the prepared anode.

### Example 5

An anode was manufactured in the same manner as in Example 1, except that a polyacrylic acid binder (55.1 mol % of PAA), a copolymer of polyacrylic acid (PAA) and polyvinyl alcohol (PVA), as shown in Table 1 was used instead of the polyacrylic acid binder used in Example 1.

A pouch-type lithium secondary battery was manufactured in the same manner as Example 1 using the prepared anode.

### Example 6

An anode was manufactured in the same manner as in Example 3, except that 2.4 wt % of the polyacrylic acid-based binder used in Example 3 and 0.6 wt % of SBR were used.

A pouch-type lithium secondary battery was manufactured in the same manner as Example 1 using the prepared anode.

### Example 7

An anode was manufactured in the same manner as in Example 3, except that 2.73 wt % of the polyacrylic acid binder used in Example 3 and 0.27 wt % of SBR were used.

A pouch-type lithium secondary battery was manufactured in the same manner as Example 1 using the prepared anode.

### Example 8

An anode was manufactured in the same manner as in Example 3, except that 2.86 wt % of the polyacrylic acid-based binder used in Example 3 and 0.14 wt % of SBR were used.

A pouch-type lithium secondary battery was manufactured in the same manner as Example 1 using the prepared anode.

### Example 9

An anode was manufactured in the same manner as in Example 3, except that 1.71 wt % of the polyacrylic acid-based binder used in Example 3 and 1.29 wt % of SBR were used.

A pouch-type lithium secondary battery was manufactured in the same manner as Example 1 using the prepared anode.

### Comparative Example 1

An anode was manufactured in the same manner as in Example 1, except that 1.39 wt % of carboxymethyl cellulose (CMC) and 1.61 wt % of SBR (Young's modulus 8.4 kPa) as shown in Table 1 were used instead of the polyacrylic acid-based binder and SBR used in Example 1.

In the case of carboxymethyl cellulose, the amount required for dispersing a slurry is less compared to the polyacrylic acid-based binder. If an excessive amount of carboxymethyl cellulose is added, viscosity of the slurry may increase, so the solids content should be lowered, negative effects, such as binder migration, may increase, and the resistance of the electrode may increase significantly. Therefore, if carboxymethylcellulose is added at the same weight ratio as the weight ratio of the polyacrylic acid-based binder to the SBR in Example 1, it may be difficult to evaluate the battery characteristics. In order to compare at a level having adhesion similar to that of Example 1, the weight ratio of carboxymethylcellulose to SBR was adjusted to be smaller in Comparative Examples 1 and 2.

A pouch-type lithium secondary was battery manufactured in the same manner as Example 1 using the prepared anode.

### Comparative Example 2

An anode was manufactured in the same manner as in Example 1, except that 1.39 wt % of carboxymethyl cellulose (CMC) and 1.61 wt % of SBR (Young's modulus 24.2 kPa) as shown in Table 1 were used instead of the polyacrylic acid-based binder and SBR used in Example 1.

A pouch-type lithium secondary battery was manufactured in the same manner as Example 1 using the prepared anode.

### Comparative Example 3

An anode was manufactured in the same manner as in Example 1, except that a polyacrylic acid binder (43.2 mol % of PAA), a copolymer of polyacrylic acid (PAA) and polyvinyl alcohol (PVA), as shown in Table 1 was used instead of the polyacrylic acid binder and SBR used in Example 1.

A pouch-type lithium secondary battery was manufactured in the same manner as Example 1 using the prepared anode.

### Comparative Example 4

An anode was manufactured in the same manner as in Example 1, except that SBR (Young's modulus 8.4 kPa) as shown in Table 1 was used instead of the SBR used in Example 1.

A pouch-type lithium secondary battery was manufactured in the same manner as Example 1 using the prepared anode.

### Comparative Example 5

An anode was manufactured in the same manner as in Example 1, except that SBR (Young's modulus 29.1 kPa) as shown in Table 1 was used instead of the SBR used in Example 1,

A pouch-type lithium secondary battery was manufactured in the same manner as Example 1 using the prepared anode.

TABLE 1

| | | | PAA molar ratio | |
|---|---|---|---|---|
| | | Young's | (%) in | Weight |
| | Binder | modulus of | PAA-based | ratio of |
| | type | SBR (kPA) | copolymer | PAA SBR |
| Example 1 | PAA + SBR | 10.1 | 49.3 | 1:0.5 |
| Example 2 | PAA + SBR | 15.8 | 49.3 | 1:0.5 |
| Example 3 | PAA + SBR | 24.2 | 49.3 | 1:0.5 |
| Example 4 | PAA + SBR | 10.1 | 43.2 | 1:0.5 |
| Example 5 | PAA + SBR | 10.1 | 55.1 | 1:0.5 |
| Example 6 | PAA + SBR | 24.2 | 49.3 | 1:0.25 |
| Example 7 | PAA + SBR | 24.2 | 49.3 | 1:0.1 |
| Example 8 | PAA + SBR | 24.2 | 49.3 | 1:0.05 |
| Example 9 | PAA + SBR | 24.2 | 49.3 | 1:0.75 |
| Comparative | CMC + SBR | 8.4 | — | — |
| Example 1 | | | | |
| Comparative | CMC + SBR | 24.2 | — | — |
| Example 2 | | | | |
| Comparative | PAA | — | 43.2 | — |
| Example 3 | | | | |
| Comparative | PAA + SBR | 8.4 | 49.3 | 1:0.5 |
| Example 4 | | | | |
| Comparative | PAA + SBR | 29.1 | 49.3 | 1:0.5 |
| Example 5 | | | | |

### Evaluation of Anode and Secondary Battery

### 1) Adhesion of Anode

Each of the anodes prepared in Examples 1 to 9 and Comparative Examples 1 to 5 were cut to have a width of 18 mm and a length of 150 mm, and then a tape having a width of 18 mm was attached to the anode current collector and sufficiently adhered using a roller having a load of 2 kg. Thereafter, an anode mixture layer was adhered to one side of a tensile tester (IMADA, DS2-50N) using double-sided tape, and then the tape attached to the anode current collector was fastened to the other side of the tensile tester.

Thereafter, a 90-degree peel test was performed to measure adhesion between the anode current collector and the anode mixture layer, and results thereof are shown in Table 2 below.

### 2) Volume Expansion Rate of Anode

A thickness (SOC 0, T₁) of each of the anodes manufactured in Examples 1 to 9 and Comparative Examples 1 to 5. Thereafter, the secondary battery manufactured using the anode was charged under the conditions of cut-off if it reaches a current value corresponding to 5% of the design capacity and CC/CV 0.33 C-rate 4.2V at room temperature (25° C.), and thereafter, the battery was disassembled and the anode was recovered.

After measuring the thickness (SOC 100, T₂) of the recovered anode, a volume expansion rate (V_{D} (%)) of the anode was calculated using Equation 1 below, and results thereof are shown in Table 2 below.

$${V}_{D} ( \% ) = [ ( {T}_{2} - {T}_{1} ) / {T}_{1} ] \times 100 \qquad [ Equation 1 ]$$

### 3) Battery Resistance Characteristics (DC-IR)

For each of the secondary batteries manufactured in Examples 1 to 3 and Comparative Examples 1 to 7, the SOC 50 was set at room temperature (25° C.), and after a rest period of 1 hour, the voltage V₀ of the batteries was measured.

Next, the voltage V₁ of the batteries was measured after discharging at 1 C current I for 10 seconds.

Resistance was calculated by Equation 2 below using each of the voltages V₀, V₁, and current values, and results thereof are shown in Table 2.

$$R = ( {V}_{0} - {V}_{1} ) / I \qquad [ Equation 2 ]$$

### 4) Capacity Retention Rate

For each of the secondary batteries manufactured in Examples 1 to 9 and Comparative Examples 1 to 5, voltages corresponding to SOC 4 and SOC 98 of the batteries were measured, the batteries were CC/CV charged to the voltage corresponding to SOC 98 and CC discharged to the voltage corresponding to SOC 4 to measure a discharge capacity in one cycle.

Charging and discharging were repeated for 800 cycles, and the discharge capacity at 800 cycles was measured in the same manner as above. Capacity retention rate was calculated using Equation 3 below, and results thereof are shown in Table 2 below.

[Equation 3]

Capacity retention rate (%)=[(discharge capacity of 800 cycles)/(discharge capacity of 1 cycle)]×100

TABLE 2

| | | Volume | | Capacity |
|---|---|---|---|---|
| | Adhesion | expansion | DC-IR | retention |
| | (N/18 mm) | rate (%) | (mOhm) | rate (%) |
| Example 1 | 0.34 | 36.3 | 1.05 | 89.9 |
| Example 2 | 0.34 | 35.5 | 1.04 | 90.2 |
| Example 3 | 0.34 | 34.1 | 1.05 | 90.3 |
| Example 4 | 0.34 | 37.0 | 1.02 | 88.4 |
| Example 5 | 0.27 | 36.6 | 1.11 | 87.1 |
| Example 6 | 0.31 | 34.2 | 1.03 | 89.9 |
| Example 7 | 0.29 | 34.1 | 1.02 | 89.8 |
| Example 8 | 0.26 | 34.0 | 1.1 | 87.3 |
| Example 9 | 0.41 | 35.1 | 1.14 | 83.3 |
| Comparative | 0.35 | 38.1 | 1.05 | 79.4 |
| Example 1 | | | | |
| Comparative | 0.34 | 38.0 | 1.08 | 79.9 |
| Example 2 | | | | |
| Comparative | 0.22 | 34.2 | 1.1 | 86.5 |
| Example 3 | | | | |
| Comparative | 0.35 | 36.9 | 1.05 | 88.6 |
| Example 4 | | | | |
| Comparative | 0.33 | 34.2 | 1.16 | 81.8 |
| Example 5 | | | | |

The anodes for lithium secondary batteries of Comparative Examples 1 and 2 used a mixture of carboxymethyl cellulose and SBR, which are commonly used as binders and did not include a polyacrylic acid-based binder, in which, it can be seen that, the volume expansion rates of the anodes were about 38% or greater, showing severe volume expansion, and the capacity retention rates were very low at 79.4% and 79.9%, respectively.

Meanwhile, the anode for a lithium secondary battery of Comparative Example 3 used only a polyacrylic acid-based binder as a binder, and it can be seen that the cell characteristics were inferior due to high resistance and low capacity retention rate. The low cell characteristics is presumed to be due to low adhesion between a copper-foil and an active material layer due to the use of a polyacrylic acid-based binder alone, thereby resulting in an increase in internal resistance, from the result of low adhesion characteristics.

Meanwhile, the anodes of Examples 1 to 3 used a polyacrylic acid-based binder including the same molar ratio of polyacrylic acid at 49.3% and had the Young's modulus of the SBR adjusted to 10.1 kPa, 15.8 kPa, and 24.2 kPa, respectively. Even though the polyacrylic acid-based binder was used as a binder, the adhesion thereof was equivalent to or better than that of the anodes of Comparative Examples 1 and 2 using the binder combining SBR and carboxymethyl cellulose, unlike Comparative Example 3. Furthermore, due to the characteristics of adhesion, excellent results were shown in terms of internal resistance.

Meanwhile, it can be seen that the anodes of Examples 1 to 3 exhibited a volume expansion rate similar to that of Comparative Example 3, providing an effect of suppressing volume expansion compared to Comparative Examples 1 and 2. Furthermore, since the volume expansion of the anode can be suppressed, and the capacity retention rate was significantly improved compared to Comparative Examples 1 and 2.

The anodes of Examples 4 and 5 had the same Young's modulus of 10.1 kPa as the SBR and the molar ratio of polyacrylic acid adjusted to 43.2% and 55.1%, respectively. Compared to the anodes of Comparative Examples 1 and 2, the effect of suppressing volume expansion and the effect of improving capacity retention rate are provided.

However, when compared to Examples 1 to 3, the anodes of Examples 4 and 5 exhibited a high volume expansion rate of 36.6% or greater and a low capacity retention rate of 88.4% or less. Therefore, it can be seen that the anode for a lithium secondary battery including a polyacrylic acid-based copolymer including 43.3 to 55.0 mol % of polyacrylic acid may further suppress the volume expansion of the silicon anode material and improve adhesion with the electrode.

The anode of Comparative Example 4 had the same molar ratio of polyacrylic acid of 49.3% as in Examples 1 to 3 and the Young's modulus of the SBR adjusted to 8.4 kPa. The volume expansion rate was high at 36.9%, and the capacity retention rate was only 88.6%. This is considered due to the use of SBR having a low Young's modulus of 8.4 kPa, which causes the SBR to lose elasticity thereof in the process of shrinking and expanding as the volume of the anode expands due to the silicon-based anode active material, and thus, the original state thereof was not recovered.

Furthermore, the anode of Comparative Example 5 was also a case in which a mixture of SBR and a polyacrylic acid-based binder was used in the same manner as Examples 1 to 3, and the volume expansion rate was low at 34.2%, indicating that the effect of suppressing volume expansion was excellent. However, the anode of Comparative Example 5 had somewhat weak adhesion and exhibited a very high internal resistance value. The SBR used in the anode of Comparative Example 5 has a high Young's modulus of 29.1 kPa, which has the effect of suppressing the volume expansion of the silicon-based anode active material due to low elasticity of the SBR, but since stability of SBR was significantly reduced and was not uniformly dispersed in the slurry, resulting in an increased resistance and a low capacity retention rate.

Therefore, it can be seen that the anode for a lithium secondary battery including SBR having a Young's modulus of 10.1 kPa to 29.0 kPa may suppress volume expansion, improve capacity retention, and improve adhesion to the electrode, while increasing battery capacity.

Meanwhile, the anodes of Examples 6 to 9 had the same molar ratio of polyacrylic acid-based binder and Young's modulus of SBR as that of Example 3 and had the polyacrylic acid-based binder and styrene-butadiene binder adjusted to have the weight ratio of 1:0.25, 1:0.1, 1:0.05 and 1:0.75, respectively.

The anodes of Examples 6 and 7 had a weight ratio of SBR to the polyacrylic acid binder of 0.1 or more, and it can be seen that the adhesion is high, the battery resistance characteristics are excellent at 1.03 mOhm and 1.02 mOhm, and the volume expansion rate and capacity retention rate are within an excellent range.

Meanwhile, the anode of Example 8 has 0.05 as a weight ratio of SBR to the polyacrylic acid binder, and it can be seen that, compared to the anodes of Examples 6 and 7, adhesion was low and the resistance was significantly increased.

In addition, the anode of Example 9 has 0.75 as a weight ratio of SBR to the polyacrylic acid binder, and it can be seen that the volume expansion rate is high at 35.1% and the capacity retention rate is low at 83.3% compared to Examples 6 and 7. Therefore, it can be seen that the effect of suppressing the volume expansion of the anode may be maximized when the weight ratio of the SBR to the polyacrylic acid binder is 0.5 or less.

The anode for a lithium secondary battery according to an embodiment may improve the lifespan characteristics of the lithium secondary battery because the volume expansion of the silicon-based anode active material is suppressed during charging and discharging of the lithium secondary battery.

According to another embodiment, the anode for a lithium secondary battery may improve the adhesion between the anode mixture layer and the anode current collector and improve the lifespan characteristics of the lithium secondary battery because the volume expansion of the silicon-based anode active material is suppressed and additional adhesion is granted between the anode mixture layer and the anode current collector.

The anode for a lithium secondary battery according to another may improve embodiment the lifespan characteristics of the lithium secondary battery because an increase in resistance during charging and discharging of the battery may be prevented even the anode having high capacity and high energy density is manufactured.

Only specific examples of implementations of certain embodiments are described. Variations, improvements and enhancements of the disclosed embodiments and other embodiments may be made based on the disclosure of this patent document.

What is claimed is:

1. An anode for a lithium secondary battery, the anode comprising:
an anode mixture layer including a silicon-based anode active material and a binder,
wherein the binder includes styrene butadiene rubber (SBR) and a polyacrylic acid (PAA)-based binder, and
the SBR has a Young's modulus of 10.1 kPa to 29.0 kPa.

2. The anode of claim 1, wherein the SBR has a Young's modulus of 15.8 kPa to 24.2 kPa.

3. The anode of claim 1, wherein the polyacrylic acid-based binder includes polyacrylic acid, a polyacrylic acid-based copolymer, or combinations thereof.

4. The anode of claim 3, wherein the polyacrylic acid-based copolymer is a copolymer of polyacrylic acid and any one selected from polyacrylic amide, polyimide, polyvinyl alcohol, and combinations thereof.

5. The anode of claim 1, wherein the polyacrylic acid-based binder includes a polyacrylic acid-based copolymer including 43.3 to 55.0 mol % of polyacrylic acid.

6. The anode of claim 1, wherein the binder includes a polyacrylic acid-based binder and SBR in a weight ratio of 1:0.1 to 1:1.

7. The anode of claim 1, wherein the anode mixture layer includes 2.4 to 5 wt % of a binder.

8. The anode of claim 1, wherein the silicon-based negative active material is at least one selected from the group consisting of SiOx (0≤x<2), SiOx doped with a metal element, and SiC.

9. The anode of claim 1, wherein the anode mixture layer further includes a carbon-based anode active material.

10. The anode of claim 1, wherein the anode mixture layer includes 5 to 80 wt % of a silicon-based anode active material.

11. A lithium secondary battery comprising:
a cathode, the anode of claim 1, and a separator.
